(19) United States
(12) Patent Application Publication
(10) Pub. No.: US 2013/0218776 A1
(43) Pub. Date: Aug. 22, 2013

(54) MONEY ALLOCATION SYSTEM

(71) Applicants: Stephen Robert Monaghan, Chatswood (AU); Shaun Robert Warren, Clementi (SG); Arthur Fewell Lees-Rolfe, Summerstrand (ZA)

(72) Inventors: Stephen Robert Monaghan, Chatswood (AU); Shaun Robert Warren, Clementi (SG); Arthur Fewell Lees-Rolfe, Summerstrand (ZA)

(21) Appl. No.: 13/818,807

(22) PCT Filed: Aug. 26, 2011
(86) PCT No.: PCT/US11/49375

§ 371 Date: May 6, 2013

Related U.S. Application Data
(60) Provisional application No. 61/377,362, filed on Aug. 26, 2010.

(51) Int. Cl. G06Q 20/40

(52) U.S. Cl. CPC G06Q 20/405
USPC 705/44

(57) ABSTRACT

At a high level, software 125 and/or a computer 400A running the software can be interfaced with a banking account 401 to specify how money can be spent. The user may access his or her bank account through an interface portal 501. The interface portal may allow the consumer to access his or her account 401 with a bank or other financial institution 400A. The bank may employ a web server 450 to send a webpage to the transferor. Using a computer 502, the transferor 500 can log into the bank (bank 1) 400A and access his or her account. The bank (both bank 1 400A and bank 2 400B) may be interfaced with a mapper server 100.

### PRIORITY CLAIM

This application claims the benefit of priority to U.S. Provisional Application 61/377,362 filed Aug. 26, 2010, hereby incorporated by reference in its entirety.

### FIELD OF THE INVENTION

This application generally relates systems and methods for controlling the alienability of money, through establishing and utilizing a payment map and/or payment mapper. Stated differently, aspects of the present invention provide systems and methods for allowing an individual/company/government to control at an individual product level how money is spent by themselves or others.

### BACKGROUND OF THE INVENTION

The generally accepted definition of money is that what makes money ‘money’ is that it has two attributes: a store of value and a medium of exchange. While money is easy to transfer to another entity, it is often difficult to control what the other entity does with the money.

Before describing in detail how the invention works, it is important to differentiate what it is not. In prior art methods, when a user wants to set aside money for a specific purpose, the user would often open a separate account so that money may be saved into an account to be used for that purpose. For example, a person may decide to save up to enough money to pay for a big-ticket item such as a plasma television. To prevent himself or herself from diverting that money to other purchases or expenses, he or she will typically open a separate savings account in order to separate the ‘television’ money from other money used for ‘normal’ expenses. If in addition he or she wants to save up for a car or a house, he or she may wish to open additional and separate accounts as a way of keeping track of progress in relation to achieving his or her individual savings goals. This approach does have some shortcomings though. For example, while the user would know that the money in the savings account is for the TV, the user can always withdraw the money and use it for other purposes, as generally only the access to the money itself is limited by the financial institution, the use thereof is usually controlled by the account holder. Moreover, money gifted to the user's TV savings account could similarly be used for any purpose the user wants.

While the multiple account setup does provide some benefit of giving the user a mental note as to where the money should be spent, an inherent problem with opening and managing multiple accounts exists. Namely, financial institutions often charge to maintain each open account, thereby discouraging the practice of opening several (or many accounts). Each account may have separate user names, passwords, account numbers, checks, cards, etc., and so it often isn't practical for a user to own or operate many accounts. Aspects of the present invention seek to find a better way to provide control over how electronic money is spent. There are at least three other important mechanisms in the prior art that companies use to limit the flow of money. The first involves the use of a contract in association with a product. For example, a cell phone service provider might agree to sell a phone at a steep discount ($200 for an $800 value phone) provided that the consumer guarantees to purchase a specified service from them for a period of time, thereby allowing the cell phone company recoup their money. Aspects of the present invention provide a simpler, more reliable, and more elegant solution for a company which wants a guarantee its consumer will purchase a certain amount of services in the future.

Another mechanism companies use to limit the flow of money is to build proprietary designs for consumable portions of a product. For example, a manufacturer might be willing to sell a printer at a low price if it can force its consumers to buy ink at a higher profit. Currently printers are built using custom cartridge configurations and use proprietary ink designs which may cause damage to the printer if third party inks are used. Printer companies also reserve the right to void warranties if their premium price ink is not used. Aspects of the present invention may allow printer companies to build printers designed to accept regular ink with a standard cartridge, while still making sure the consumer spends enough money with the manufacturer to make the sale of the printer worthwhile.

A third option is the type of product that acts as a proxy for the type of goods that are sold, such as in Control system from MasterCard and Orbiscom (http://www.mastercard.com/us/company/en/newsroom/pr_orbiscom.html) that allows one to limit spending by merchant type. Put another way, if the user has limited spending on stationery to $100 for a specified period, then any transaction (from a Merchant that is defined as being a stationer) that causes that limit to be exceeded will be rejected by the card systems. Aspects of the present invention may allow for controls to be implemented at the product level and not just at the merchant level.

Another important problem left unsolved in the prior art surrounds the situation wherein a person gives or donates money to someone or an institution with the intention that the money is to be used for a specific purpose, or conversely, with the provision that the money is not spent on items that the giver considers to be inappropriate. Other than through the use of vouchers there are no known techniques for guaranteeing that the recipient of the money will use it for the desired purpose of the giver. A classic example is a richer person may give money to a poorer person for the purpose of buying food, but instead the poorer person purchases alcohol. As a result, richer people do not give poorer people money as frequently as they might because the poorer person may not use the money as desired by the richer person. The richer person has no practical manner of controlling the spending of the poorer person. The US government has long realized this problem, wherein money is provided to a poor person for food, but the poor person does not always use the money to buy food with it. To counter this problem, the government invented food stamps, a specific type of currency that can only be used to buy food.

One of the current methods employed in certain of the states in the USA is the use of an electronic system of validating that the goods that are being purchased (specifically for the Women, Infant, Children or WIC program) are what the program intends it for. Reference http://www.fns.usda.gov/apd/Library/WIC_EBt_docs.htm for more information on this system.

### SUMMARY OF THE INVENTION

At a high level, the invention generally relates to methods and systems for guiding, regulating, managing, controlling, and/or directing how and for what money is used. For example, in certain configurations, a mapping system to regulate which items a consumer buys from a merchant. Through the systems and methods disclosed below, a user of the mapping system may have the ability to limit or limitation how funds can be used. Certain embodiments of the invention may also be used with cash (non-electronic money) through interfacing the directed payments system with barcodes, RFID tags or any future identity technology associated, imprinted, or embedded in the cash. In some configurations, the expenditure of cash can be controlled, as long as the physical money can be individually identified electronically.

A consumer may be a person shopping in a mall for shoes, a company shopping online for a service contract, a person being offered services in exchange for money, a church purchasing electricity, a government agency hiring a contractor, or any natural person or legal entity desirous of consuming and/or purchasing goods and/or services. A user of the present invention may be a consumer, but a user may also be an individual or legal entity gifting money, saving money, limiting the use of money, etc. Broadly, a user is simply a person or legal entity interfacing with one of the disclosed systems or practicing one of the disclosed methods. A merchant is a shopkeeper, distributor, producer, contractor, service company, manufacturer, or natural person or legal entity desirous of providing and/or selling goods and/or services. A financial institution is a corporation or other legal entity engaged in the business of providing financial services to a user (including a merchant), typically a bank, but may not be a registered financial institution but any institution that offers services that involve the use, storage or distribution of money. The merchant and the consumer may have a financial institution and it may be the same institution or the institutions may be separately owned or controlled. A mapper server contains one or more computers as defined below, wherein the computers contain software for causing the system to carry out a set of instructions.

One way a user may interface with his financial institution or the mapper server is by using a computer. In some cases, the computer may be a small computer such as a cell phone, smart phone, laptop, personal digital assistant, or other portable computer, however the term computer itself should be considered to be any computing device having a processor or circuitry for processing software containing instructions stored on computer readable media (e.g. memory, hard drive). A computer may contain other components such as a display, Ethernet circuitry, memory, bus, hard drive, power supply, or components. The computer(s) the financial institution or mapper server uses are likely larger and more powerful (i.e. servers) to handle the increased processing loads these computers may need to handle.

One aspect of the invention may relate to adding a limitation for actions or goods that have been defined in a computer system. The limitations may allow or deny a particular transaction or use of money. The repository of the listings of limitations may be stored as a limitation map in a database connected to a server and one or more financial institutions. A mapper server may be used to generate and access these maps. In some embodiments, the mapper server, in essence, can map a set of limitations to specific units of money. This mapping need not be limited to one account. The mapping may create specific limitations against specific money and its use in one or more accounts. In the event of mapping against a credit account like a credit card account (where there may be no specific money that exists in the account) the mapping is against the credit in the credit account. The same is true of any credit granted such as an overdraft facility for example.

Some embodiments of the invention feature various ways of determining which products or services are being obtained in exchange for money from the user in a transaction. A transaction platform may be used to identify goods and services as part of the process of authorization of the payment. A system such as PCT/US11/44700 filed Jul. 20, 2011, incorporated herein by reference in its entirety, may be used for passing a product identifier of an individual product to a transaction platform.

Mapping may be performed in many ways. For example a user may map his or her own money that they are intending to use themselves. Or, a transferor (giver) may place limitations on money prior to transferring it to a transferee (recipient).

In the first instance, the user may set up limitation maps through interfacing with a website maintained by his or her financial institution. The mapper server may be connected to the financial institution and needs to be a financial institution that has subscribed to the directed payments system, so that the mapping system is thus implemented in that financial institution and consequently is available to the consumer. The mapping software may be run on a mapper server that may be controlled by the financial institution, or it may be independently controlled. The mapper server may be a component within the financial institution's computing system or it may exist as a separate server. Some embodiments of the mapper server may be configured so that the owner of the money or account has full rights to add, remove, or modify limitations to any of the money in the account. In other embodiments, a user may have limited rights to delete or modify limitations. Such an embodiment may be useful for parents to control how their children spend money for example. The mapping technology may also be created so that if a person or entity is in receipt of money having limitations, that person can only add further limitations, but cannot remove existing limitations.

A second use of the mapping technology may allow a transferor (person/entity giving or transferring the money) to map limitations regarding how the recipient of the money may use it. In some cases, the mapper server may be configured so that the transferor cannot impose limitations on the recipient. For example, an employer generally cannot impose limitations on money paid to an employee in the normal course of business as payment for work performed. Whereas, if the employer were transferring money to the employee for future travel expenses, the mapper server may be configured to allow the employer to impose limitations on the money.

An example of one way money may be transferred using a configuration of the present invention may include: A transferor logs in to his or her financial institution's web portal. The user indicates to the financial institution that he or she wishes to initiate a transfer by way of wire transfer for example. The user can indicate how much money he or she wishes to transfer, as well as the financial institution and receiving account information. The transferor's financial institution may be configured to determine whether the recipient's financial institution is a subscriber to the mapper server technology. If the recipient's financial institution is a subscriber to the mapping system then the transferor's financial institution can optionally offer to the transferor the ability to apply limitations to the money that the transferor is intending to transfer. If the transferor decides to avail themselves of the mapping facility, then if the money that is to be transferred has not been mapped in the account already, then this would need to be done in a similar manner to what has been covered above. On receiving the money transfer the mapper server of the receiving financial institution will recognize and apply the mapping that is associated with the incoming transfer of money that has mapping attached to it, to their own map database and associate the map with the money that has been transferred into the receiving account. The recipient would now have the money available in their own account but with the map server limitations applied to its actual use.

In some embodiments the mapping is not to balances in the account, but to the actual money in the account. This means that every single unit of money in the account has a mapping in the map database associated with it, and consequently one can ‘track’ the actual money through the financial system. So long as the recipient's account is a subscriber to the mapper server, then the actual money—and not just a balance—can be tracked through various financial systems. This may be useful for tracking money in investigations on money laundering for example.

Some embodiments of the present invention resolve the issue of setting the limitation at a product level discussed with reference to the in Control system by allowing the user to set the limitations at the product level as opposed to the retailer level. For example, a limitation relating to the amount of paper for a photocopier may be set, while allowing the unlimited purchasing of pens. Both of these products can be purchased from stores—such as supermarkets—that would not be classified as stationery or office supply stores. The inventors have found that the in Control system would require an extremely detailed classification of potential merchants to work, making the system very difficult to maintain and build. A better solution is to classify at the product level, and use the existing product identifiers (UPC, GTIN, etc) to compare against the stored mapping of the invention.

### BRIEF DESCRIPTION OF THE FIGURES

FIG. 1: illustrates a first embodiment of a system comprising a mapper server, map database and product/services database, and two financial institution computer systems, catering for a sales transaction.

FIG. 2: illustrates a second embodiment of a system comprising a mapper server, map database and product/services database, and two financial institution computer systems, where the transaction is not a sales transaction.

FIG. 3: illustrates a second embodiment of the embodiment of FIG. 1, featuring a messaging module.

FIG. 4: is a schematic view of the steps involved in enrolling a financial institution into an embodiment of the present invention;

FIG. 5: is a schematic view of the steps involved in enrolling a user into an embodiment of the present invention;

FIG. 6: is a schematic view of the steps involved in an embodiment of the present invention of a user creating a map of limitations against money in an account at an enrolled financial institution;

FIG. 7: is a schematic view of the steps involved in an embodiment of the present invention of a user transferring money with limitations attached to it to another entity that has an account at an enrolled financial institution;

FIG. 8: is a schematic view of the steps involved in an embodiment of the present invention of a user changing the map of limitations against money in an account at a financial institution, where they have received that money from another entity with limitations attached;

FIG. 9: is a schematic view of the steps involved in an embodiment of the present invention of a user performing a sales transaction using money in payment thereof that has got limitations attached to it;

FIG. 10: is a schematic view of the steps involved in an embodiment of the present invention of a user creating a group or groups and subgroups of products that will be referred to by the present invention when reviewing the limitations applied to the money;

FIG. 11: is a schematic view of the steps involved in an embodiment of the present invention of a user performing a sales transaction using money in payment thereof that has got limitations attached to it where one of the limitations is based on an attribute of the person and another limitation is based on a locality parameter;

FIG. 12A: is a schematic view of the steps involved in an embodiment of the present invention of a user transferring money with limitations attached to it to another entity that has an account at an enrolled financial institution and the second entity rejecting the receiving of money with limitations;

FIG. 12B: is a schematic view of the steps involved in an embodiment of the present invention of a user transferring money with limitations attached to it to another entity that has an account at an enrolled financial institution where the second entity requests of the first to change the limitation;

DPM stands for Directed Payments Money which is used as a potential, future commercial name for the mapper server technology systems, methods, and processes described herein.

### DETAILED DESCRIPTION OF THE INVENTION

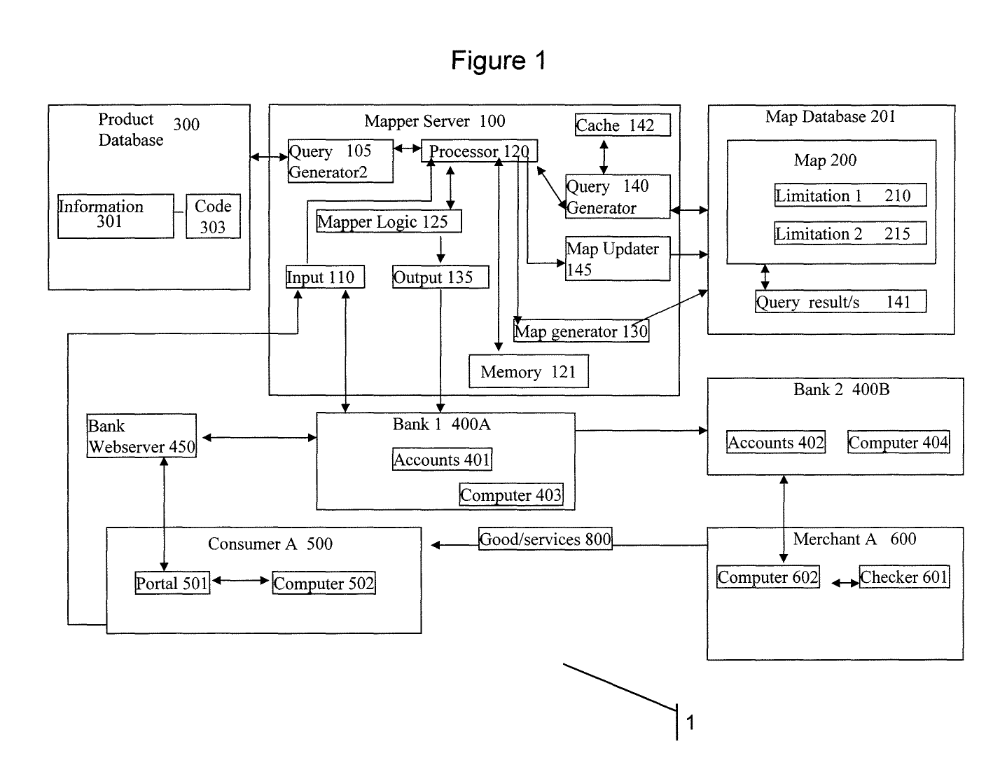

At a high level, software 125 and/or a computer 400A running the software can be interfaced with a banking account 401 to specify how money can be spent. As shown in FIG. 1, the user may access his or her bank account through an interface portal 501. The interface portal may allow the consumer to access his or her account 401 with a bank or other financial institution 400A. The bank may employ a web server 450 to send a webpage to the transferor. Using a computer 502, the transferor 500 can log into the bank (bank 1) 400A and access his or her account. The bank (both bank 1 400A and bank 2 400B) may be interfaced with a mapper server 100. The mapper server 100 may also be integrated into the bank's system, or the bank may have an interface 450 for accessing the mapper server 100. The mapper server 100 is used for making maps 200 which place limitations 210 relating to transferring money from a transferor 500A to a transferee 500B.

To help explain the various embodiments of the present invention, a number of examples and scenarios will be presented. The titles of the examples and scenarios are non-limiting.

### Consumer Merchant

As shown in FIG. 1, suppose a consumer (a person or other legal entity) 500 has $100 in a transaction account 401 with bank 1 400A. Bank 1 400A is connected to the mapper server 100 which can generate maps 200. Bank 1 400A also provides webserver access 450 to the account holder 500. If the consumer 500 wants to create maps 200—which may be stored in a map database 201, controlled by a map server 100 using a computer readable media like a hard drive—he may access the mapper server 100 through 450 the bank 400A (or in some embodiments directly). A map generator 130 can create the map 200 and store it in the map database 201. Suppose the consumer 500 creates a map as follows:

Account X

$20—Food

$50—Television

$30—unallocated.

When the consumer 500 wants to spend some of his money from the transaction account 401 (say with a debit card) at a merchant 600, his bank 400A will interface with mapper server 100. Merchant A 600 may have a checker or scanner 601 which links with bank A 400A directly or through a processor service 700. The checker 601 may also be embodied as an RFID reader, a barcode reader, or other interrogator type device which can discern an identifier from a product 800. Good or service 800 can be nearly any good or service for sale such as a product, raw materials, a laptop, tobacco or a subscription, or a contract to repair a building. The checker 601 can be attached to a computer 602 physically or wirelessly, and may contain a computer itself.

In example 1, consumer A 500 brings $35 of products 800 to merchant A 600, and merchant A 600 uses a checker 601 (a device comprising a computer or being connected to a computer for reading product identifiers such as bar codes) to connect with bank A 400A, and send a query to bank 1 400A resembling the following question, “Does consumer A 500 have $35 in account X 401 for purchasing the following products 800?”. In some embodiments, the checker 601 will send a set of product identifiers to bank 1 400A. The checker 601 “knows” to send the request to Bank 1 401/1, because the consumer 500 presented his or her bank 1 400A information in the form of a debit card. However, certain embodiments of the invention may be performed where the checker 601 does not know which bank 400A the consumer 500 is using. However, in the current example, Bank 1's 400A computer 403 would receive the product identifiers 800 from the checker 601. This information may be encrypted so that the bank 400A cannot collect information about the products 800 the merchant 600 creates. In those embodiments, the mapper server 100 might have a key to decrypt the merchant's 600 encryption or cryptographic 165 encoding, which the bank 400A does not have. The bank 400A would then send the product 800 identifiers to the mapper server 100. The mapper processor 120 would receive the product 800 identifier 303 from the bank 400A, and determine that the bank 400A is requesting authorization to purchase these products 800. To determine whether or not to authorize the purchase, the mapper server 100 can query a product database 300 for product information 301. To do this, the processor would direct a map database 201 query generator 140 to send a look-up request to the mapper database 201. Generally, the map database 201 query generator 140 will look-up each product 800 identifier and see if there is any limitation 210 that is mapped against it—remembering that if there is no explicit limitation the money is in the ‘unallocated’ group. However, the mapper server 100 may contain a cache 142 for remembering queried 140 product 800 results. To perform the look-up, the product database 300 query generator 105 may create a query to the product database 300 such as, “Provide product mapping information for UPC 055712100142.” For this UPC 303, the product mapper server database could return the following information to the mapper server:

Member of the following groups:—“food” 301
The mapper server 100 may send the other UPCs 303 (or other product identifiers 303) to the product mapper server database 201 via the map database 201 query generator 140. The product mapper server database 201 can return a set of results 141 for each UPC 303. In continuing the above example, the products 800 consumer A 500 is attempting to buy are the following:
1 Kleenex
6 Cans of Coke
4 pounds of Turkey
1 Entertainment magazine
½ pound of cheese
10 bottles of beer
   The mapper server 100 would then direct the map database 201 query generator 140 to send a query to the map database 201 to determine what map/s 200 is present in the consumer's 500 map database 201. In this example, the consumer 500 has the following map 200: —

$20—Food

$50—Television

$30—Unallocated.

This mapper processor 120 can determine there are two groups of products 800 to process: food and television. There are many ways the mapper server processor 120 could determine whether the products 800 the consumer 500 is attempting to buy comply with the above map 200. For example, the mapper server processor 120 may link the products 800 with the received codes 300.

| | |
|---|---|
| 1 Kleenex | $3 |
| 6 Cans of Coke | $5 |
| 4 pounds of Turkey | $20 |
| ½ pound of cheese | $6 |
| 1 Entertainment magazine | $4 |
| 10 bottles of beer | $18 |

The mapper server processor 120 may have the mapper logic 125 determine whether these products 800 can be purchased considering the consumer's 500 map 200. The mapper logic 125 may perform the following analysis to reach that decision:

Is Kleenex Food? No. Is Kleenex Television? No. Is there sufficient Unallocated funds to cover purchase? Yes. Deduct $3 from Unallocated funds.

Is Cans of coke food? Yes. Is there sufficient Food funds to cover purchase? Yes. Deduct $5 from Food.

Is Turkey Food? Yes. Is there sufficient Food funds to cover purchase? No. Are there sufficient funds between Food and Unallocated yes. Deduct $15 from Food. Deduct $5 from Unallocated. (Food now is $0; Television $20; Unallocated $22).

Is Entertainment magazine Television? The answer could be Yes or No depending on how the algorithm to determine the answers is programmed. The algorithm may return a Yes, because the magazine relates to television, or the algorithm may return a No, if the algorithm is set to limit the purchases to physical televisions. Let's assume it return a Yes. If so, $4 is deducted from the Television amount.

Is Cheese Television? No. Is there sufficient Unallocated funds to cover purchase? Yes. Deduct $4 from Unallocated. (Notice, that in this embodiment, the logic skips requirements which are depleted to save clock cycles in the processing.)

Is Beer Television? No. Is there sufficient Unallocated funds to cover purchase? No, there is only $16 left of unallocated funds.

The mapper logic 125 may then return the following instructions back to the processor 120. Authorize purchase of Kleenex, Cans of Coke, Turkey, Cheese, Magazine. Decline Beer. Food=$0; Television=$46; Unallocated=$16. The processor 120 may receive this information and update the consumer map 200 through the map updater 145. The processor 120 may then send or output 135 an authorization to the bank 400A or payment processor 700 to authorize the transfer of funds of $20+$4+$14=$38 to Bank 2 400B. Bank 1 400A may also send which products 800 are authorized for purchase and which ones are not authorized. Bank 2 400B then may send this information to the merchant's 600 computer 602. The merchant sees that all the purchases 800 are authorized except the beer. To conclude the sale, the merchant's 600 account 402 in Bank 2 400B now has $38 of the consumer's 500 money from Bank 1 400A. The consumer 500 now has all the above items except for the beer. (The consumer 500 may have the option to change the purchases 800, to substitute the beer for the cheese for example, which involve repeating the above process. This might be performed at a customer services desk for example.)

The algorithm may also be configured to simply approve or deny an entire purchase depending on whether the consumer has sufficient funds to make the purchase. For example, let us assume that consumer A 500 brings $60 of food to purchase from merchant A 600. Merchant A 600 uses the checker 601 to register the goods 800 being purchased, and then sends a query 615 to bank 1 400A resembling the following question, “Can consumer A 500 purchase these items 800?” The bank 400A would forward the query to the mapper server 100. The mapper server 100 determines that consumer A 500 has $20 allocated for food and $30 unallocated, so the mapper server 100 replies “No.” Bank 1 400A or mapper server 100 (depending on the embodiment) informs the merchant 600 that consumer A 500 does not have enough money in the consumer's account 402 to pay for the goods or services 800. Note, the limitations 210 in the map 200 create this result, even though the total amount of money in the consumer's 500 account 402 exceeds the current charge ($100 total−$60 charge.) The mapper server 100 or bank 1's 400A computer 403 may be configured to inform the merchant 600 why the purchase is being declined; i.e. there is not $60 in the account 402 which is transferrable for food purchases. Alternatively, a simple “No” could be sent to the merchant 600, and a more detailed answer 144 sent to the consumer 500. Also, more or less information could be shared with the merchant 600 depending on the privacy setting desired by the consumer 500 or imposed by the bank 400A. For example, when provided with the product identifier 303 (e.g. barcode information, GTIN, etc) of the product 800, the bank 400A could just send a message to the checker 601 that the purchase is declined (no reasons given.) There is a risk that the consumer 500 might not know why the purchase is being declined necessitating a visit to the bank's 400A website 405 or a call to the bank 400A. To reduce the confusion to the consumer 500, the consumer 500 may request (or the bank 400A may choose to provide) additional information 144 as to why the purchase is being declined.

### Building the Maps

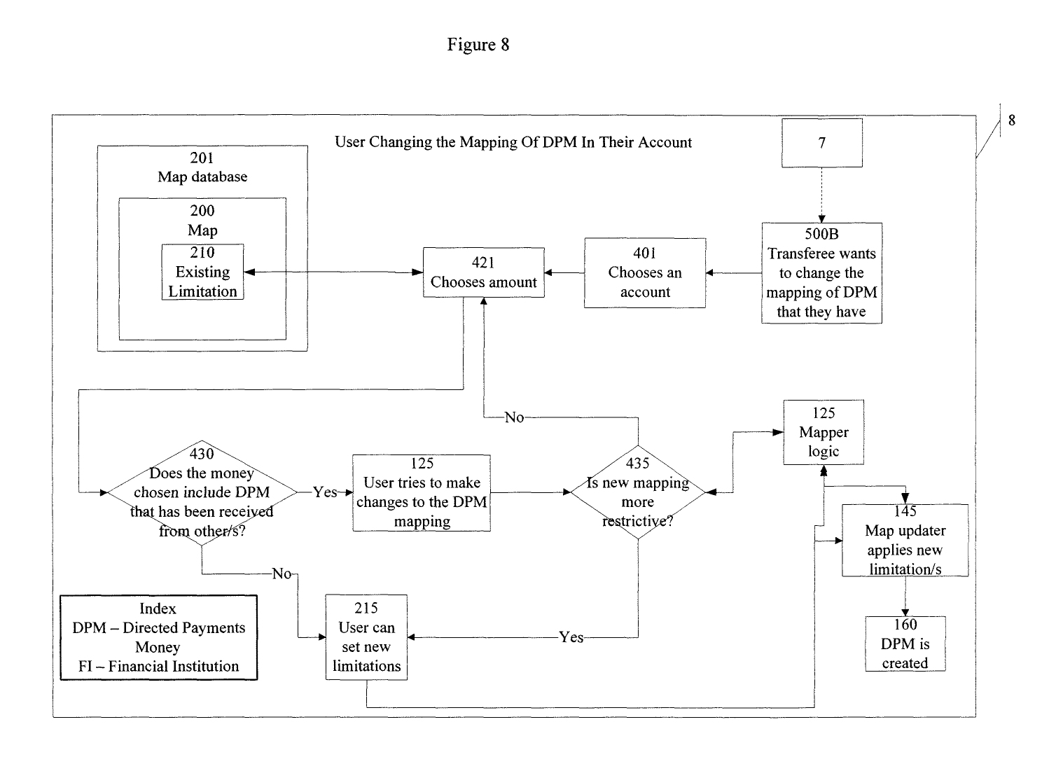

In the previous two examples, the process flow assumed there were already pre-populated maps 200 in the database 201. In addition to illustrating a purchase transaction, FIG. 8 also illustrates how the consumer 500 might add, reduce, or modify maps 200 in his or her database 201. The consumer 500 will typically begin by determining the product/service 800 that they wish to use or define a limitation 210 for, and using the mapper logic 125 they can apply a limitation 210 to the money in the account 401 through the map updater 145. By default, all money in the account that has not been mapped to a specific limitation 210 will be given the status of ‘unallocated’. The consumer 500 has now successfully applied a limitation map 200 to the money in that account 402.

### Supply Chain

Certain configurations of the invention may allow funds to be allocated back through the supply chain systems from a participant (“company A”) in the supply chain back to another participant (“company B”) in the supply chain. In this example, company B purchases raw materials and processes them in some manner before passing on the goods to company A, which processes them further. If A has a lower cost of capital than the company that it is intending to advance mapped money to, then the provision of mapped money up front to company B—that can only be spent on the raw material that company B buys (to process and pass on to company A)—may result in a better price of that raw material to B since B can pay its supplier immediately and not have to wait for cash to come in from trading activities.

In some embodiments, external parties may participate in the supply chain using the same functionality. For example, a financial institution 400A may have been approached by company B (as per the example above) for working capital to enable them to purchase products 800 such as raw materials for processing and passing on to company A. Such money may have a map 200 of limitations 210 generated by the lender bank 400A to a specific set of uses (buying specific materials) so that the money cannot be used to pay a bonus, but can only be used in the purpose to which it has been limited 210. In such an embodiment, the financial institution 400A may do this as a condition of the loan, so that it is reducing the risk involved in said loan.

As compared to the example of a cell phone provider in the “Background of the Invention,” the user 500 could agree to create a map 200 for a certain amount of money 210 to spend on services 800 from the cell phone provider. In some configurations of the invention, once the map 200 has been created 145 it cannot be changed by the consumer 500, thereby forcing the consumer 500 to spend the money on the designated service 210 since the money cannot be used for anything else. Similarly, the printer manufacturer could require the consumer 500 to map a certain amount of money for purchasing ink 210 in order to buy the printer at a special price.

One aspect of the invention surrounds the question as to how the merchant 600 determines what type of good 800 is being sold. For example, how can the merchant's 600 checker 601 determine whether the item 800 to be purchased is food? One way to do this would be to scan or read an identifier 303 (e.g. the UPC, RFID, EAN tag or barcode) on the product 800. Typically the mapper system 100 will use this information 303 to determine the permitted use of the money in the account 402 that the consumer 500 has specified 210 for the transaction. The merchant 600 may also have his or her computer 602 determine from the scanned identifier 303, what type of product 800 the item is.

### Extra Features

Certain embodiments of the invention will allow for integration of logistics systems, product identity systems, location systems (GPS, time circuit, Global Location Number (GLN), or local location services), and other systems that provide additional data about a specific transaction, or where a transaction takes place 605. In certain embodiments of the invention, the directed payment system 100 can gather additional information 605 at the point of sale. In these embodiments, a GPS chip and/or time circuit may be provided on the consumer's 502 and/or the merchant's computer 602.

### Mapping Features

Some embodiments of the invention may feature advanced mapping techniques such as nesting, conditional, or Boolean mapping. For example, if the system's mapping software 125 implements conditional mapping, the consumer 500 may be able to create a map like this:

### Conditional Mapping 1

$20—food
$50—television
$30—unallocated if the $30 is spent before Jul. 10, 2015; else $10—books.

### Conditional Mapping 2:

$20—food
$50—television
$30—unallocated. Any amount not spent by dd/mm/yyyy to be returned to giver.

### Boolean Mapping:

$20—food OR alcohol

$50—television

$30—unallocated NOT television

### Nested Mapping:

$20—food

Nested Limitations
Food cannot be Pork
   If food is not pork, cannot have alcohol as an ingredient

$50—Television

$30—unallocated NOT television

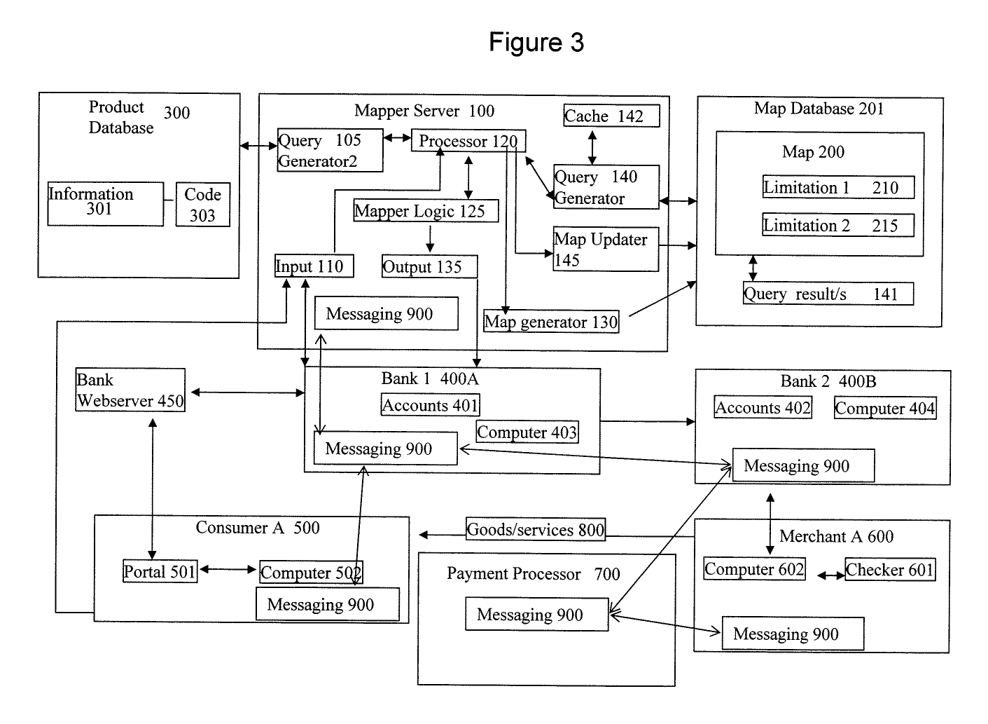

FIG. 3 is similar to FIG. 1 with the addition of some of the message flows that are envisaged, left off FIG. 1 for clarity.

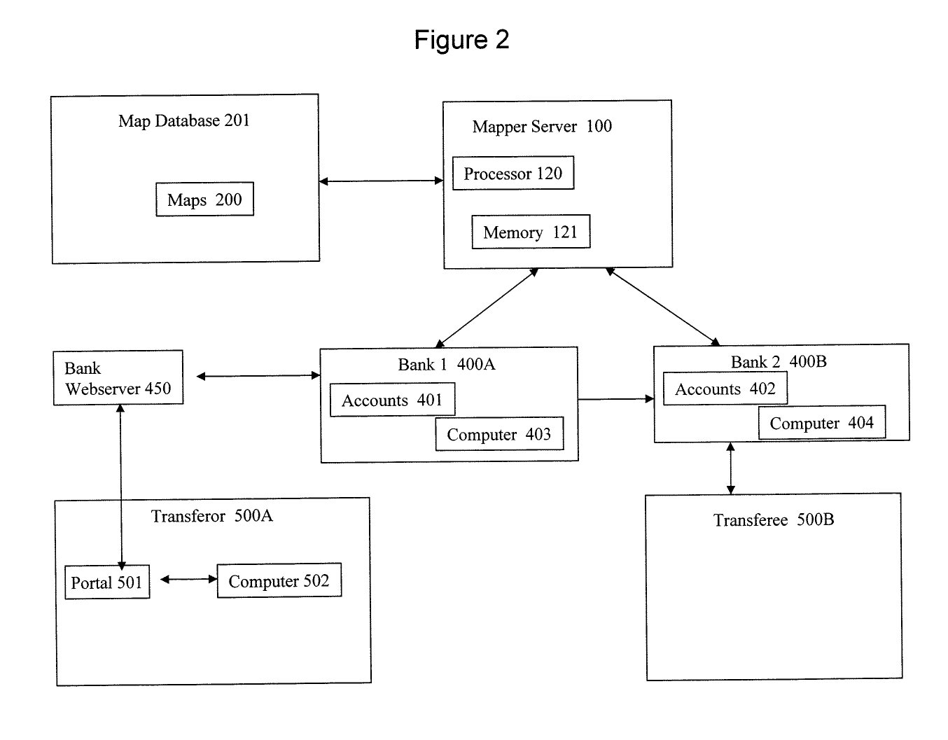

FIG. 2 illustrates a similar functionality to FIG. 1, with the difference that the recipient or transferee of the money is not a merchant that is receiving money for goods or services. Certain configurations of the invention may allow the owner of the money to impose limitations 210 on the use of the money prior to transferring it to a receiver of the money (transferee 500B). For example, a company 500A might transfer $2000 to an employee 500B for the purpose of providing the employee 500B with money to purchase a laptop for working from home. Here's an example of how the transaction may take place:

Company A's bank 400A sends a request to employee A's bank 400B to receive an electronic disbursement of funds using a computer 403. Company A's bank 400A interfaces to employee A's bank 400B and electronically requests confirmation whether employee A's bank 400B can accept a limitation 210 on the disbursement to products 800 to be purchased from the employee's account 402. Employee A's bank 400B sends a confirmation message in response, i.e. this bank is a subscriber of an embodiment of the invention 100. Company A's bank 400A transfers $2000 and a message to employee A's bank 400B, the message imposing the following condition on the $2000:

$2000 of the money in this account may be spent only laptops.

Employee A's bank 400B adds the condition 210 to any other conditions 210 which may already be present in the account 402. To use an earlier example, say employee A's bank 400B account 402 had $100 inside it before the transfer with the following conditions:

### Before Transfer:

$20—Food

$50—Television

$30—unallocated.

### After Transfer:

$20—Food

$50—Television

$30—unallocated

$2000—laptop

If the employee 500B were to attempt to spend money from this account 402 he could spend up to $2030 on a first product such as a laptop, but could spend no more than $50 on a second product such as food.

In the same example above, the company 500A can impose a mapping 210 on the money that on a certain date in the future any unused portion of the money will be returned to them. In this manner the company 500A is ensuring both that the money is only spent on a laptop, and that any money that is unused for that purpose is returned to the company 500A.

Similar type limitations 210 could be applied for the example discussed in the background involving the rich and poor person. As deployed embodiments of the invention become more popular, poorer people may set up accounts 402 with banks 400B for receiving money from richer people so that the poorer people can accept limited funds 100. Assume rich person A encounters poor person A, and wants to give the poor person $20 for food. Rich person could contact his bank 400A using for example a portable computer 502 (mobile phone, laptop, etc) and request that $20 from the rich person's account 401 be transferred to the poor person's account 402. To assist in maintaining the privacy of both individuals' accounts, a money transfer system could be used to transfer the money without revealing private information to either person e.g., PCT/US2011/044700, herein incorporated by reference in its entirety. In addition, when the money is transferred from the rich person's account 401 to the poor person's account 402, the following use limitation 210 could be added to the account 402:

$20—food

Indeed, the US or state government could use this same technique to give money to poor people rather than utilizing food stamps. An embodiment of the invention can be used in a country like the United States to meet all the requirements of the WIC program without needing to have individual State implementations. The recipients would receive money that has a map 200 applied to it and this limits what they can spend it on, as well as potentially returning to the state the unused portions.

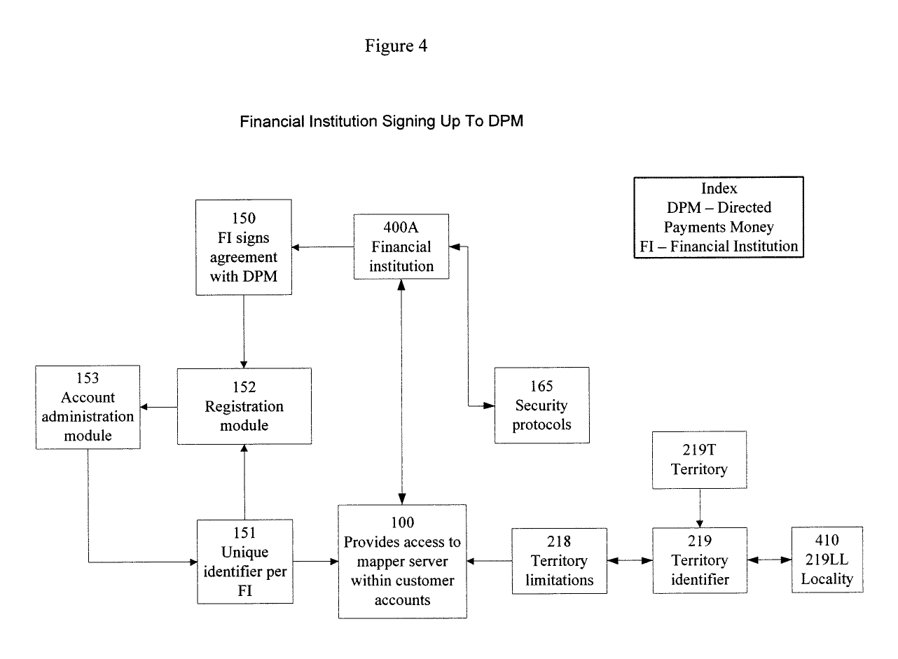

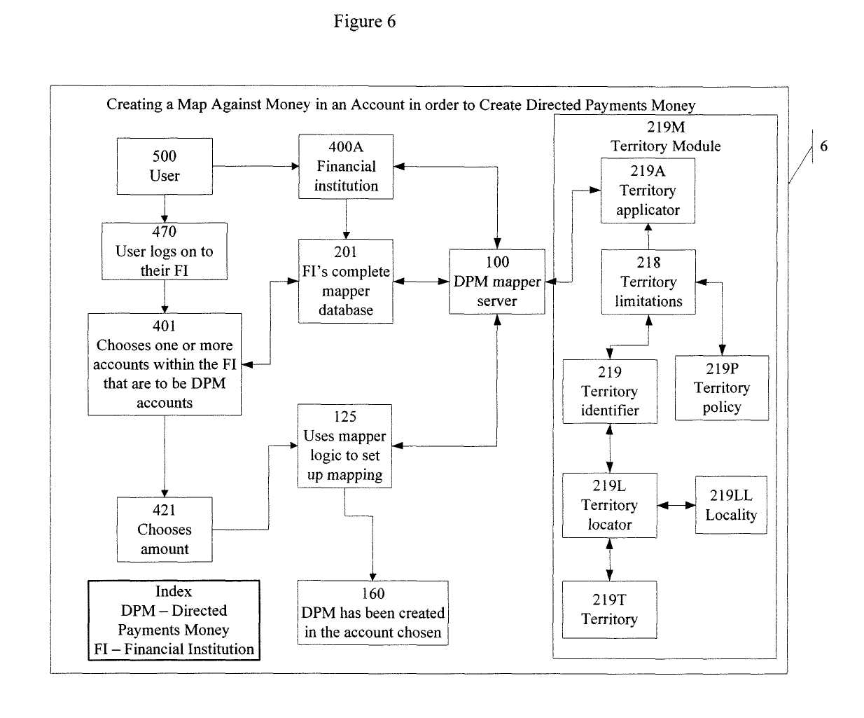

FIG. 4 shows the initial process that a financial or other institution would need to do to register into the system of the invention. The financial institution 400A would sign an agreement 150 with the invention to allow the financial institution 400A to use the invention. Through the use of a registration module 152 the financial institution is registered to the system and a unique identifier 151 for that institution is issued. The financial institution is also provided with a cryptographic platform 165 or security protocols, and standard rules 218 that cannot vary for the territory 219 as described in FIG. 6. A territory 219 is a defined geographic area and can be a county, ward, province, state, or any defined geographic area. A territory limitation 218 is a limitation for that territory 219 that is imposed or legislated to that territory 219 by a competent body. A typical example of a standard limitation 218 for a territory 219 would be that no person 500 below the age of 18 years may use their account 401 to purchase a product 800 such as alcohol.

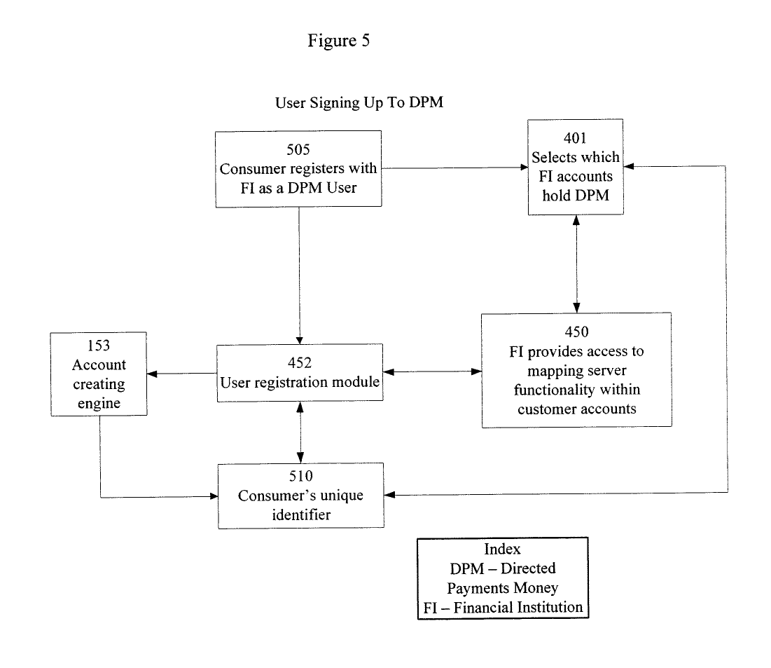

FIG. 5 illustrates the initial process of a user of financial institution services that wishes to make use of the invention system and method. The user is herein called a consumer 500. The consumer 500 registers with the financial institution through a user registration module 452 that is provided through the financial institution for this purpose. The consumer is registered within the invention using an account administration module 153 and a unique identifier 510 is issued as a result. The consumer 500 then chooses which account/s 401 are to be designated as DPM accounts.

FIG. 6 illustrates a user 500 allocating money in an account 401 to have limitations 210. The user 500A logs on 470 to their financial institution 400A and chooses the account 401 that they wish to make DPM in. The user 500A will make use of the mapper database 201 and mapper logic module 125 in conjunction with the mapper server 100 and the standard territory limitations 218 to create or allocate or input limitations 210 in the account 401 specified for the money 421 selected. The territory module 219M is used by the invention to define territory policies 219P and to define the boundaries of the territory itself 219 such that the result of the policies 219P and the territory boundaries 219 are reflected in the territory limitations 218 that are standard to that territory 219. The territory limitations 218 are applied to the map 200 of the relevant financial institution 400A through the territory applicator 219A.

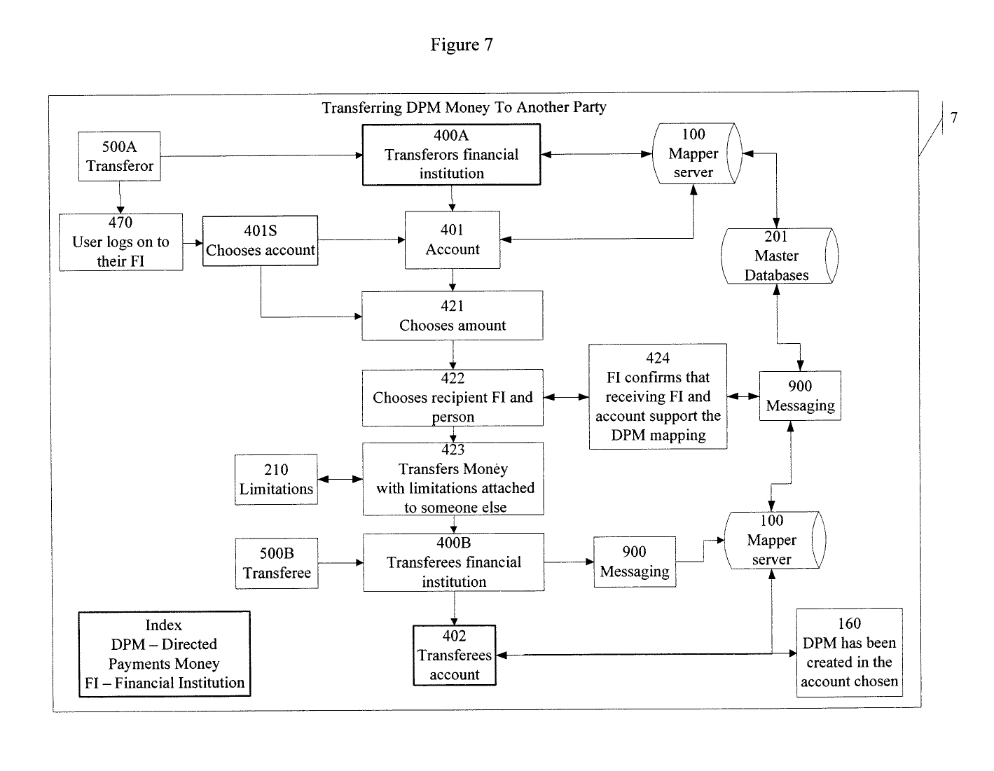

FIG. 7 illustrates the steps in one party transferring money to another, said money that has limitations 210 attached to its use. The transferor 500A logs on 470 to their financial institution 400A and chooses 401S the account 401 that they wish to transact with. Having chosen the amount 421 that they wish to transfer, they choose a transferee 500B financial institution 422 and the system may confirm 424 that the transferee 500B financial institution 422 does support the invention methods and systems. The transferor 501A will apply limitations 210 if they are not already in place, and will then instruct his financial institution 400A to effect a transfer or payment 423 into the account 402 of the transferee's 500B financial institution 400B. On receipt by the transferee 500B financial institution 400B, the transferee's 500B account 402 will be credited with the amount transferred 423, and simultaneously a message 900 will be sent to the mapper server 100 in use by that financial institution 400B to update its map databases 201 with the limitation/s 210. Messaging 900 will also confirm to the master databases 201 that the mapping and limitations 210 are in place, and consequently money with limitations 210 or DPM money 160 has been credited to the transferee's 5008 financial institution's 400B account 402.

FIG. 8 illustrates an additional feature of the mapping software 100 in that it may be configured to allow the owner of the money that has money 160 in their account that is associated with a limitations 210 to add additional limitations 215. 7 represents FIG. 7 as above. For example, a parent may transfer money to a child with the limitation 210 that is cannot be used to buy a product 800 such as alcohol. The child could choose that money 421 and add the limitation 215 that the money can also not be used 210 to buy a product 800 like tobacco. Also, the mapping software 100 may be configured so that it would not allow a change using the mapper logic 125 from “no alcohol” to “no beer” because “no beer” is narrower 435 than “no alcohol”, and would then allow the money to be used to purchase wine. Conversely, some embodiments of the mapping software 100 may be configured to allow a change 435 from “no beer” to “no alcohol” because “no alcohol” is broader 435 in scope and thus more limitative 210. However, programming the software 125 to recognize broader limitations 210 from narrower limitations 215 may be difficult or time consuming, and so embodiments of the invention may simply not allow a recipient 500B to change or delete any pre-existing limitations 210 on the money. Accordingly, a user 500 that wants to add “no beer” to his list of limitations 210 would simply add “no beer” as an additional limitation 215 in addition to “no alcohol 210”. To remove a limitation 210, like “no alcohol”, a transferee 5008 can return the money to the transferor 500A, and request the transferor 500A transfer the money without the limitation 210. Successful changes in the limitation's 210 are updated into the map database 201 via the map updater 145. In the event that a user 500A wants to set or change limitations 210 on money that was theirs and which had not 430 had limitations 210 applied to it from others, then they would have unfettered ability to apply new limitations 215.

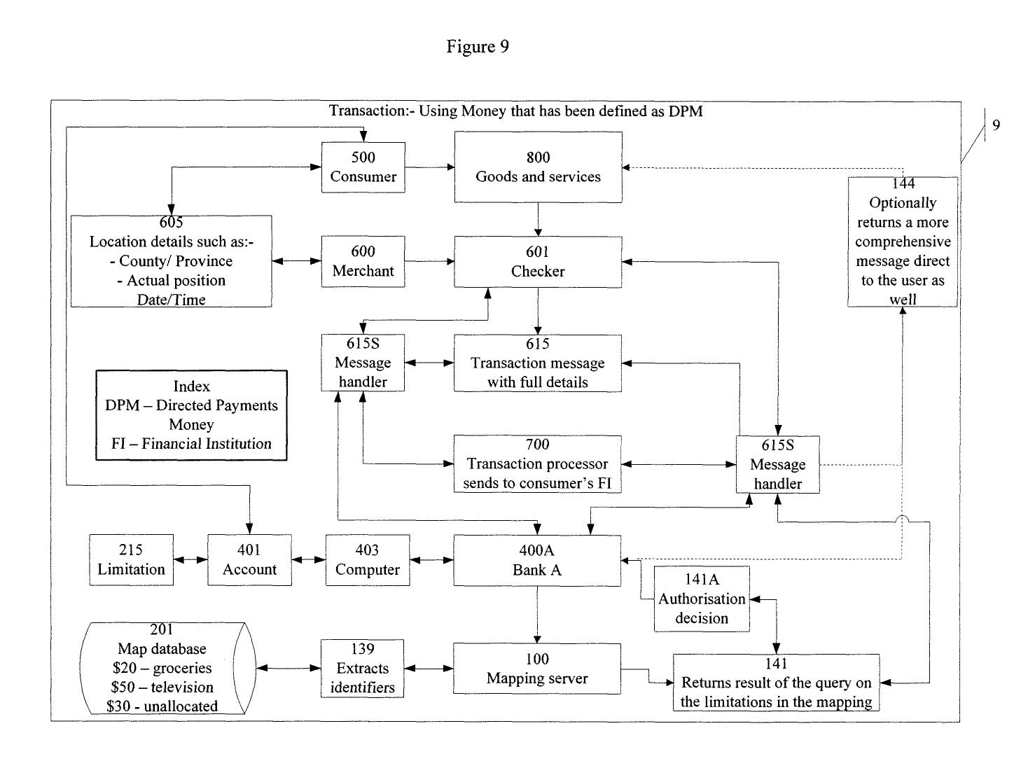

FIG. 9 illustrates the steps in the process of effecting a sales transaction with the use of money that has had limitations 210 applied to it. In this illustration the consumer 500 chooses goods or services 800 that they are desirous of purchasing. Note, this example is valid for purchases that are done where the consumer 500 is physically at the merchant's 600 store, or a remote purchase, such as via the telephone or interne/web. The merchant 600 uses the checker 601 to register the items chosen. The merchant's system will then forwards 615S a message 615 containing the full details of the goods/services 800 being purchased to a transaction processor 700 for payment authorization. The transaction processor 700 will forward 615S the message 615 to the appropriate financial institution 400A for authorization. The financial institution 400A forwards 615S the message 615 to their mapping server 100 which contains limitations 210 that have been defined in a map database 201. The mapping server 100 will extract 139 the product/service identifiers 303 from the message 615 to compare with the limitation 210 in the map database 201. Based on the result 141 that the map database 201 returns, the financial institution 400A forwards 143 the transaction processor 700 with the appropriate result 141. This message response 143 is then forwarded back to the checker 601. Optionally the consumer 500 can be messaged 144 directly by the invention system 100 or by the financial institution 400A.

FIG. 9 also shows an example of additional embodiments of the invention that may feature a mapper server 100 that checks for conditions based upon time and location 605. For example, town A may prevent any consumer 500 from purchasing alcohol before 12:00 on Sundays within the borders of the town. The town also could force (through passing a law or rule) the mapper server 100 to place the following map 215 in all consumer's 500 accounts 401.

If time is between 00:00-12:00, location 605 equals town A, and day of the week equals Sunday, NOT alcohol for all funds.

In example 1, assume consumer A 500 enters alcohol store A at 10:00 AM, in town A, on Sunday, and in example 2, assume consumer A 500 enters alcohol store B at 10:00 AM, in town B, on Sunday. Also assume consumer A 500 has $100 in his account A 402 with no limitations 210 that the consumer 500 has set himself. Example 1, consumer A 500 presents the alcohol purchases to the merchant 600 at grocery store A. The merchant 600 rings up the purchases, and using the checker 601 requests permission to charge $50 of purchases to account A 401. Bank A 400A checks consumer A's 500 account 401 and requests the checker 601 send its location 605 to the bank 400A. The checker 601 responds it is in town A 605 (or in some embodiments it may provide GPS or other location coordinates). Bank A 400A determines that the time, town, and day of the week conditions are met 215, and then declines to authorize the purchase since the goods 800 being purchased are alcoholic beverages. Whereas in example 2, when the checker 601 sends its location 605 to bank A 400A, bank A's 400A computer 403 determines that the town's geographic condition 605 evaluates to false, and authorizes the purchase.

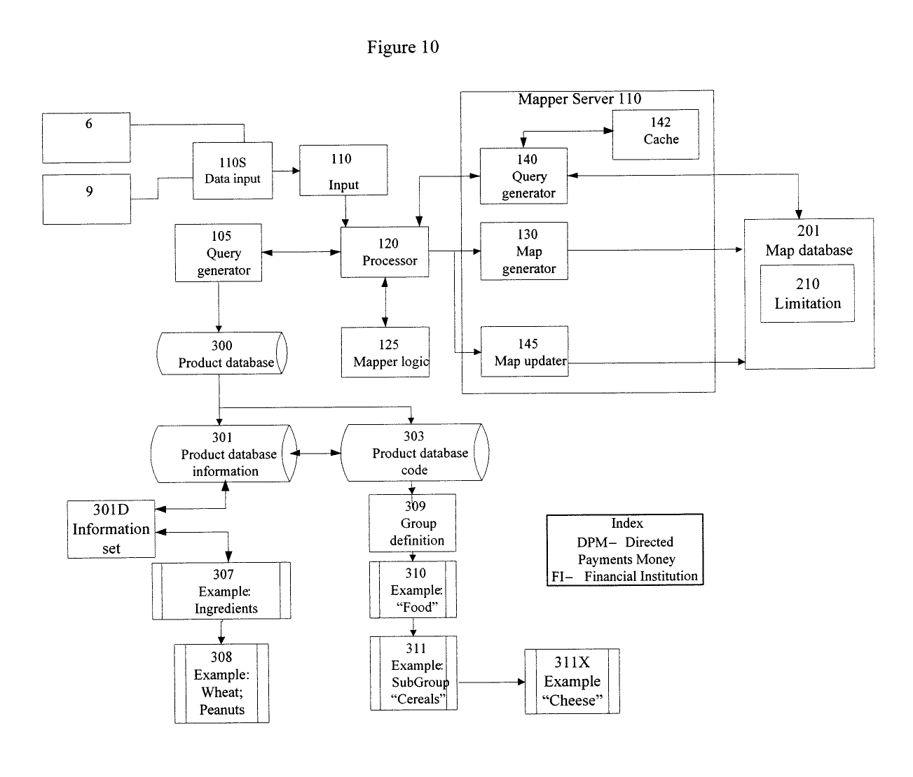

FIG. 10 illustrates a configuration of the invention that may provide the user 500 the ability to limit purchases for his or her own 500 benefit based upon the ingredients 307 of a product 500. 6 is FIG. 6 and refers to the creating of a map 200 of limitations 210 against money. 9 is FIG. 9 and refers to the process steps of effecting a transaction with limited 210 money. If, for example, using the method described in the description of FIG. 9, a user 500 is allergic to foods in a particular group 310 or subgrouping 308 such as peanuts, he or she may set a limitation 210 using the mapping software 125 to disable or warn him from buying food 800 with peanuts. In this method the user 500 would input 1105 data 110 into the mapper server processor 120 the required limitation s 210 using the map generator 130 and map updater 145 to update the map database 201. Future queries of the map database 201 through the query generator 140 would use the updated limitations 210 and the query cache 142 would be refreshed as well. Information relating to whether or not product (e.g. food) 800 grouping 310 chosen contains peanuts may be collected by the computer 403 at the financial institution 400A when the merchant 600 selling the food rings up the purchase using a checker 601. For example, the merchant 600 using a checker 601 scans a granola bar for checkout. The checker 601 would capture the UPC 303, GTIN 303, or other code 303 on the product 800, and send the code/s 303 to the transaction processor 700 in the form of a transaction message 615. The transaction processor 700 forwards the transaction message 615 to the correct financial institution 500A. The financial institution 500A would use its designated mapping computer 100 (located at or in communication with the bank 400A in some embodiments) to look up the code 303 in a map database 201. The mapping computer 100 may send a query 105 to the description database 301 to see if any of the ingredients 307 in the products 800 are peanuts. Since the granola bar contains peanuts the product database 300 would return a message to the mapping computer 100 that the product 800 did indeed contain peanuts. Since the product 800 contains peanuts the mapping computer 100 would disallow the purchase. In some embodiments, the limitation 210 of peanuts can be entered with an override feature. This feature might be added to allow the user 500 who is allergic to peanuts to purchase the granola bar for someone else for example. Note that the product database 300 may contain many sub-grouping of information including manufacturing information, serial number/s or codes, manufacturing date, manufacturing plant, country of origin, model identification code/s, component identification codes, and tracking codes. In addition to allowing a user 500 to be aware of food allergies or medicines such as penicillin, another use is for Muslim or Jewish people that may specify that products 800 they purchase should not contain pork in any grouping 310. Additionally, someone who does not wish their products 800 to contain alcohol (such as in deodorants, perfume, etc) can specify a limitation 210 that no products 800 should have a grouping 310 that contain alcohol. Such limitations 210 through the use of specific attributes 307 as described above is not limited to money that one is using for oneself, but can also be applied to money that is transferred 423 to a transferee 500B. Typically the product database 300 consists of product codes 303—such as GS1 barcodes—and related descriptions 301. Barcodes can be grouped 309 by broader definitions, so a typical group 310 may be called ‘food’, and would contain a set of barcodes that represent products 800 that are typically to be considered to be food 310. There may be multiple subgroups, so there may be a subgroup called ‘cereals’ 311 for example. There will be predefined groups 309 for the more typical groupings such as food 310 already in place, but the consumer 500 can make their own group 310 by choosing a set of products 800 and applying a group name 310 to them. Products 800 can exist in more than one group. A group 310 that the consumer 500 may wish to set up may be the codes of all of the televisions that the consumer 500 is considering buying. The group name 310 that the consumer gives to this group may be ‘televisions’. This is then a group 310 that can be applied to money to limit the use of that money to the product(s) in that group 310. Having set up the product 800 groups 310 that the consumer 500 wishes to use, the consumer 500 would then move on to creating a map database 201 for an account 402 that they have with that financial institution 400A and start the process of applying mapping 200 to the money 200. In the simplest case the consumer 500 would choose 421 all of the money in the account 402 and then apply a single product 303 or product group 310 to that money. Alternately (and assuming that the consumer 500 has $100 in that account 402) the consumer 500 would choose an amount of money 421 and apply a limitation map 201 to that money, and then move on to defining the next amount 421 of money. Using our typical example of applying a limitation 210 of $20 to be used for groceries and $50 for a television, the consumer 500 would choose the amount of $20 in the account 402 and apply the food group 310 to that amount of money. The consumer 500 would then choose 421 the next $50 of money in that account 402 and would then either choose the product code 303 of the television that they are saving up for and apply that to the $50 that had been chosen 421, or would choose the ‘television’ group 310 that they had set up as described above and apply that to the $50 that has been chosen 421.

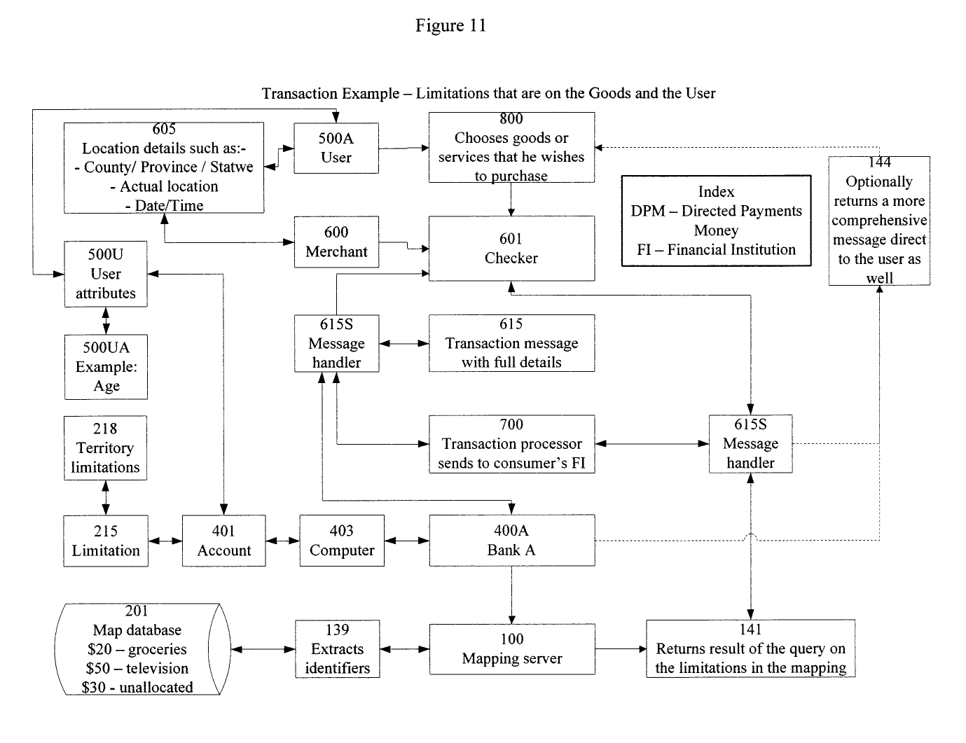

FIG. 11 illustrates another benefit of using the mapping software 100 in this context is that it may be used to alleviate a bar's 600 or liquor store's 600 need to check the patron's 500 age. This is achieved through the combination of territory limitations 218 and the user's attributes 500U. The user 500A is known to the financial institution 400A and the financial institution 400A captures certain data of a user 500A when they enroll the user 500A as a consumer 500, and the ‘know your customer’ requirements of a financial institution 400A may include the age 500U of the consumer 500A. A state A (605) may legislate that the drinking age is 21 for example. The state A 605 may impose a territory mapping limitation 218 that money in the accounts 401 of user's 500 who are below 21 years of age cannot transfer money to purchase alcohol 308. A user 500A may be 20 years of age and is allowed to purchase alcohol 303 in other states 605, and so has mapped 200 a certain amount of their money to be used for alcohol 303 purchases. On attempting to purchase 9 alcohol 303 in state A 605 the mapper logic 125 would evaluate the query result 141 as being positive for the existence of mapped money 160 to purchase alcohol 303, but negative to the territory limitation 218, and so declining the request for payment 9. The combination of these more detailed limitations also applies to those examples given under the discussion of FIG. 6.

Although aspects of the present invention could be constructed utilizing third party systems, some configurations of the invention may be constructed using only pre-existing financial institutions 400A. While a system relying on pre-existing financial institutions 400A may require the financial institutions 400A to add new software or computers 403 to their banking systems, one advantage of using pre-existing financial institutions 400A as opposed to an independent third party system is that users already have trust (to some degree) that their financial institutions 400A will properly safeguard their money. Thus it is specifically envisioned that systems and methods could be constructed which do not place any funds and/or information in any third party accounts. Additionally, systems and methods employing the transfer of funds and/or information to a third party account could be utilized with certain configurations of the present invention.

In some embodiments of the present invention, the software mapper 100 of the financial institution 400A can generate a map 200 to keep track of who 500 set up what limitation 210 on the money. For example, a map 200 might resemble the following:

| Amount | limitation | limitator |
|---|---|---|
| $20 | Food | consumer A |
| $50 | Television | consumer A |
| $30 | unallocated | consumer A |
| $2000 | laptop | Company A |

Depending on the configuration of the mapping software 125 set by the consumer's 500 financial institutions 400A, the consumer 500 may or may not have rights to modify the limitations 210 he placed on the money ($20, $50, and $30). In this particular configuration, company A 500A gave the money to consumer A 500B with the provision 210 that use of the money is limiting to purchasing laptops. Therefore, the company 500A would have included within the limitation 210 that only company A 500A can withdraw the limitation 210, and the consumer 500 in this example cannot change or delete 125 this limitation 210 of the data.

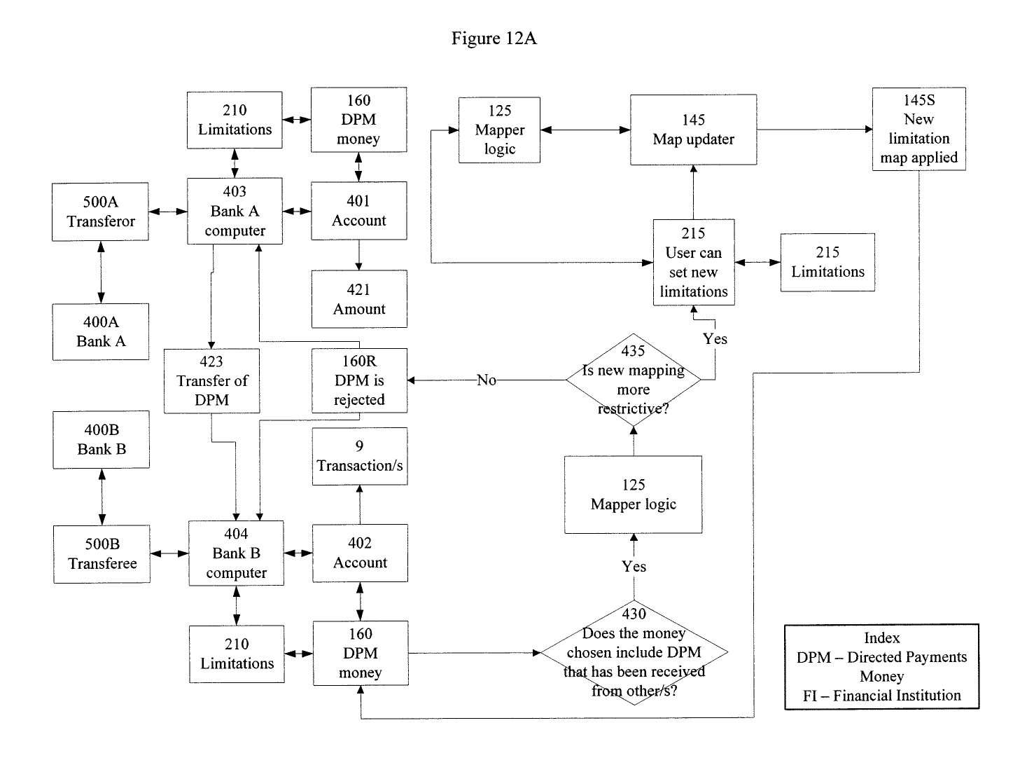

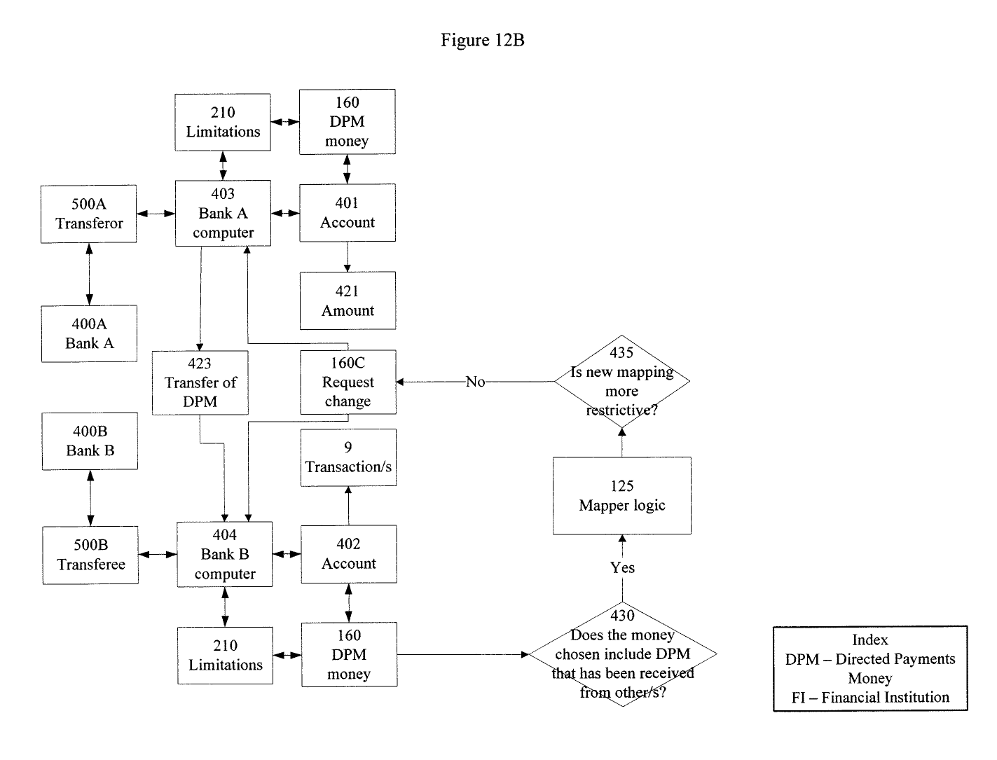

FIG. 12A illustrates the instance of where a transferor (giver) 500A of use-limited money 160 may want or need to change 8 the limitations 210 that they placed on the money prior to giving 423 it to the new owner 500B, and where the transferee 500B is now in possession of the money. The transferee 500B may have also already consumed or used 9 part of the money that was transferred 423 to him or her 500B. The computer system 404 of the bank 400B may be programmed in such a way that transferring money back 160R to the original transferor 500A is an exception to the use limitation 210 (as in this case, the transferee 500B is not transferring the money to buy a laptop.) In other configurations, the transferee 500B may view the limitation 210 through the mapper logic 125 functionality and determine that limitation 210 is not one that they are prepared to accept, and so may reject 160R the money 160 that was transferred 423 to them. In other configurations, the transferee 500B may view the limitation 210 through the mapper logic 125 functionality and determine that limitation 210 needs to be added to, and make a more restrictive 435 limitation 215 on the money 160 received, which would be in addition to the existing limitation 210. In this process the mapper logic 125 in conjunction with the map updater 145 are used to apply 145S the new rules 215 to the money 160.

FIG. 12B illustrates a configuration where the transferee 500B requests the transferor 500A to make a change to the user limitations 210 on the money 160 received. Responding to this request the transferor 500A can send a message 160C to via his banks' 400A computer 403 to the computer 404 of the bank 400B of the transferee 500B requesting the change. The bank 400B may require use its computer 404 to communicate with Banks A's 400A computer 403 to request that the transferor 500A authorize himself as the entity 500A which set the present limitation 210 on the money, and if the bank's 400B computer system 404 determines that the entity 500A requesting the change 145 in limitation 210 is the same entity 500A which set the limitations 210 on the money in the first instance, authorize 9 the change. In some configurations, the bank 400B computer system 404 may also require the transferee's 500B approval to change the limitation 210.

Aspects of the present invention may be applied to credit card purchases as well. Unlike a debit card or wire transfer, use limitations 210 on credit accounts 402 limits one's ability to spend credit, as opposed to limits on one's ability to spend owned money. Similar to standard accounts 402, mapping software 100 can be used build a map 200 associating a certain amount of money or percentage of the account with a particular charge 210. For example a consumer credit account 402 may look like this:

Total credit limit=$10,000
20%=clothes
30%=food
$50=coffee shop X
30%=hotel or airline
35%=unallocated
Also, when a consumer 500 uses credit to pay for some goods or service 800, or uses credit account 402 money for any other purpose, he or she can transfer the money and make a limitation 210 on the recipient's 500B use of the money much the same way as is discussed above.

Limitations 210 placed on money may either be pervasive (transfers with the money) or temporary (expiring when the money is transferred). Some limitations 210 may expire within a time period or when a predetermined condition occurs (Mets win the world series, a student gets 3.7 GPA, minor turns 18, must purchase laptop within 30 days, etc).

Pervasive features of money may be set so that money cannot be used to purchase contraband. In some embodiments, an appropriate regulator may have the ability to add limitations 210 to a user's 500 account 401. Access to do so may be express (with the account 401 holder's 500 permission, perhaps by contract) or by law (legislation causes certain limitations 210 to be added). Certain relationships of individuals may also have the ability to limit another's account 401 (legal guardian to child, employer/employee, etc).

In most embodiments, when money is transferred from a consumer 500 to a merchant 600, the transferred money does not retain any of the consumer initiated limitations 210—the merchant 600 takes the money free and clear of any limitation 210. In some embodiments, the transferor 500 can send money with the condition 210 that if the money is not used within a period of time or a specified condition 215 occurs (or does not occur) the money reverts back to the transferor 500. This feature may be useful when a large amount of limited 210 money is transferred, and there is a small balance. E.g. transferor 500A gives $20,000 to transferee 500B to buy a product 800 (e.g. a new car). Transferee 500B uses $19,300 for the car. Transferor 500A could include within the transfer the limitation 210 that any money not used ($700 in this instance) will revert back to the transferor 500A in thirty days 210.

Aspects of the present invention may be used to improve the way that grant or welfare money is spent. For example, suppose a social grant is given by governments to people that are in need, and the grant covers the estimated cost of various living expenses such as food and shelter. One issue potentially troubling the donor is; will the money be used effectively (not for narcotics, alcohol, gambling etc). In addition, another concern may be the problem of a middleman misappropriating the money. For example, donor A 500A gives money to charitable company A 500B so that hurricane victims in country A 605 can have food (which may be enforced through allowing a purchase based on GTIN 303 numbers for example). How does donor A 500A know that company A 500B won't skim off the donated money? One way to reduce skimming or stealing would be set up a limitation 210 that limits company A's 500B ability to do anything with the money other than transfer to victims in country A 605. Alternatively, a limitation 215 limiting how company A 500B can spend the money may also achieve the same purpose (only purchase products 800 such as food/clothes in country A 605 for example.)

The mapping software 100 may be constructed so that it disallows the user 500 from making limitations 210 when transferring money. In some cases, the transferee 500B can reject the transfer if the included limitations 210 are inconsistent with the terms of some pre-existing agreement. Alternatively, there are some instances where there would be no reason a transferor 500A should include any limitations 210 with the transfer of money, and the mapping software 100 may, at root level 125, prevent the user 500A from transferring money with the limitations 210. For example, while many users 500A might want to impose limitations 210 on how the government might use money it receives from income taxes, there are not many instances where an individual could limit how the government can spend this money. As a result, the mapping software 100 may place a limitation 210 on the user's 500A ability to create a limitation 210 on money being used to pay taxes.

The mapping software 100 may also be designed to allow insurance companies to set limitations 210 on the money they pay for insurance claims. This may help alleviate the problem where the insured and the estimator over estimate the cost of repair an item. For example, an insurance company 500A could issue money with a limitation 210 that it could only be used to buy parts or service 800 for a specific model car 303, and if any of the money was not used within a month, it would revert 215 to the insurance company 500A.

A further use of the limitations 210 as illustrated in FIG. 10 is through grouping 309 products 800 so that there are fewer iterations needed to validate the purchase. As an example, that allows for the limitation 210 to be defined as the category 309 ‘food’ 310 and thus the consumer 500 no longer would need to specify each individual UPC code 303 in order to effect the correct limitation 210. Groups 309 can be nested in logic so that a subgroup 311 of the group food 310 may be defined as ‘cereals’ 311. In the same manner there can be multiple nested groups 311, so that a block of cheese can be categorized at one level as being in the food 310 group 309, but there can be a subset of food 310 called dairy 311, and a subset of dairy 311 can be cheeses 311X, this being an example of grouping to the third level, levels of subgroups are not limited. Any code 303 can be categorized to any subgroup 311 and it will also be present in all parent subgroups 311 or group 310 as appropriate.

Aspects of the present invention may also be used to satisfy spending limitations 210 instituted by a court. Courts could limit 210 money to be used to buy certain products 800 for children if money is being transferred pursuant to alimony or child support. For example, if a man 500A is sending money to his ex-wife 500B for alimony, a court could limit 210 how she uses the money—perhaps limiting its use to food 303, transportation 303, and lodging 303. Rather than using auditing for example to make sure a court's orders are complied with, the court can simply limit 210 how the money can be used via accessing the mapper server 100 and setting the appropriate limitation 210.

1. A financial mapper system (1) for controlling a transaction (9) and transferring money in an account (401) at a first financial institution (400A) so as to restrict a computer (403) at the financial institution (400A) from transferring (423) certain funds (160) in the account (401) to a second account (402) at the same (400A) or another financial institution (400B), said mapper system (1) comprising:
a. a map database (201) featuring a map (200), each map (200) comprising a limitation (210); and
b. a mapper server (100) for determining whether a first user (500A) can direct funds from the first account (401) to a second user (500B); said server (100) containing a query generator (140) for querying the map database (201) to obtain a map (200) associated with the user (500); said mapper server (100) containing computer readable media (121) and a processor (120); and
c. mapper logic (125) stored on the computer readable media (121) and executable by the processor (120); said logic (125) containing instructions to cause the mapper server (100) to determine whether the map (200) associated with the user (500A) contains a limitation (210) that prohibits the first user (500A) from completing the transaction (9).

2. The system of claim 1, comprising a financial institution (400A) registration module (152) containing instructions for causing the computer (403) controlled by the financial institution (400A) to register the account with the mapper system (1); said account (401), when registered, being linked to the map (200) so that limitations (210) appearing in the map (200) are relevant to the first account (401); wherein the mapper logic (125) and processor (120) will utilize the limitations (210) to restrict the ability of the financial institution (400A) to transfer money (423) to the second account (402).

3. The system of claim 2, wherein said registration module (152) comprises an account-administration module (153) containing instructions to cause the computer to generate a unique identifier (151) associated with the first account (401).

4. The system of claim 1, comprising a user registration module (452) for providing a consumer (500) access to the map (200) associated with his or her account (401); said first financial institution (400A) hosting an interface (450) through which the first user (500) can access the consumer registration module (452).

5. The system of claim 1, comprising a user portal (450) for allowing a user (500) to add, modify, view, or remove limitation (210) associated with his or her (500) account (401).

6. The system of claim 1, wherein said limitation (210) is selected from the list consisting of:
a. a group (310) of goods (800) and a specified amount of funds (421) which can be used to purchase (9) the goods (800);
b. a group (310) of services (800) and a specified amount of funds (421) which can be used to purchase (9) the services (800);
c. a date and time (605) by which a specified amount of funds (421) is to be used to purchase (9) goods (800) from a particular group (310);
d. a date and time (605) by which a specified amount of funds (421) is to be used to purchase (9) services (800) from a particular group (310);
e. a locality (219LL) from which a particular (303) type (309) of goods (800) is to be purchased (9);
f. a locality (219LL) from which a particular (303) type (309) of services (800) is to be performed (9); and
g. a locality (219LL) of the first financial institution (400A) that is processing the transaction (9).

7. The system of claim 1, comprising a territory module (219M) containing a territory policy (219P) and a list of territories (219); said first financial institution (400A) associated with at least one of the territories (219); wherein association of the first financial institution (400A) with the territory (219T) causes the mapper server (100) to add (8) limitations (218) to maps (200) at the financial institution (400A) that are specified by the territory policy (219P)

8. The system of claim 1, comprising a territory module (219M) containing:
a. a financial institution (400A) territory locator (219L) for determining and linking a financial institution (400A) with a specific territory (219T);
b. a territory applicator (219A) for applying a territory policy (219P) to a financial institution (400A); said policy (219P) including a map (200) and a limitation (218) associated with the territory (219T) of the financial institution (400A);
c. a transaction territory policy (219P) containing a map (200) having a limitation (218), wherein the limitation (218) applies to a location (219LL) of an underlying transaction (9) between the first user (500A) and a second user (500B), and not a location (219LL) of the financial institution (400A);
d. said transaction territory policy (219P) containing a locked map (200) wherein neither the first user (500A) nor the financial institution (400A) can change any limitations (218) associated with the locked map (200).

9. The system of claim 1, comprising a transaction territory module (219M) for recognizing a locality (219LL) of a financial transaction (9) and linking that locality (219LL) to a specific territory (219T); said module (219M) comprising:
a. a territory locator (219L) for determining the locality (219LL) of the financial transaction (9);
b. a territory locator applicator (219A) for apply a transaction territory policy (219P) containing a locked a map (200) wherein neither the user (500A) nor the financial institution (400A) can change any limitations (218) associated with the map (200).

10. The system of claim 1, wherein the mapper logic (125) causes the processor (120) of the mapper server (100) to:
a. determine a user's (500) identity from his or her unique identifier (510);
b. access maps (200) within the map database (201) to determine if any limitations (210) should be associated with the user's (500) account (401); and
c. determine whether the user (500) has the access rights (430) to change (145) any of the limitations (210).

11. The mapper server of claim 1, comprising:
a. an input (110) to receive a unique identifier (510) from the first user (400A),
b. a processor (120) and logic (125) for directing the query generator (140) to request a map (200) associated with the user (500A) by the unique identifier (510);
c. said input (110) also receiving an invoice (615) of goods or services (800) to be purchased from the second user (500B);
d. said processor (120) and mapper logic (125) determining from limitations (210) stored in the map (200) whether the first user (500A) has authorization (141A) to pay for the goods and services (800) being offered by the second user (500B);
e. said processor (120) and logic (125) sending (615S) an instruction (615) to the first financial institution (400A) to transfer funds from the first account (401) to the second account (402) if the processor (120) and logic (125) positively determine the first user (500A) has authorization (141A) to pay for the goods and services (800); and
f. said processor (120) and logic (125) sending (615S) an instruction to the first financial institution (400A) to deny transferring funds from the first account (401) to the second account (402) if the processor (120) and logic (125) positively determine the first user has not got authorization (141A) to pay for the goods and services (800).

12. The system of claim 1, comprising:
a. a product database (300) comprising:
i. product and service identifier codes (303);
ii. groups (309) each containing at least one product or service code (303);
iii. each group (309) containing at least one subgroup (311), each subgroup containing further identifiers of the product or service code (303);
b. an information database (301) comprising:
i. an information set (301D) associated with a particular product or service (303); each information set containing:
1. a description (307) of the information set (301D) of the product/service (303);
2. components or ingredients (307) of the product/service (303);
3. supply chain information including: manufacturer of the component or ingredient, wholesaler of product or service (303), and retailer of product or service (303);
4. expiration date of the product or service (303) if the product or service (303) has an expiration date;
5. instructions selected from the set consisting of: fitting instructions, use instructions, disposal instructions, and safety instructions;
6. manufacturing information; and
7. warranty information.

13. The system of claim 11, wherein mapper logic (125) is configured to cause the mapper server (100) to:
a. prevent the first user (500A) from modifying (145) limitations (210) in the map associated with the first account (400A); and
b. allow the first user (500A) to add and apply (8) other limitations (210) to the map (200) which are more restrictive (435) with respect to existing limitations (210) in the map (210).

14. The system of claim 11, wherein mapper logic (125) is configured to cause the mapper server (100) to:
a. cause the mapper server (100) to collect information from the first institution (400A) and from the first (500A) and second (500B) users in order evaluate whether the first user (500A) has authorization (141A) to complete a transaction (9) between the first (500A) and second (500B) user; wherein the information is selected from the group consisting of: date and time (605) of the transaction (9), location (219LL) of the transaction (9), and location (219LL) of the first financial institution (400A).

15. A method for controlling and transferring money in an account (401) at a first financial institution (400A) so as to restrict a computer (403) at the financial institution (400A) from transferring (423) certain funds (160) in the account (401) to a second account (402) at the same (400A) or another financial institution (400B), said method comprising the steps of:
a. creating a map (200) having a limitation (210);
b. storing the map (200) in a map database (201);
c. using a mapper server (100) to determine whether a first user (500A) can direct funds from the first account (401) to a second user (500B);
d. creating a query using a query generator (140);
e. receiving in response (141) to the query, a map (200) associated with the first user (500A);
f. utilizing logic (125) and a processor (120) in the mapper server (100) to determine whether the map (200) contains a limitation (210) that prohibits the first user (500A) from completing the transaction (9).

16. The method of claim 15, comprising the steps of:
a. providing a financial institution (400A) registration module (152) executable by a processor (120) in the computer (403) of the financial institution (400A);
b. using the registration module (152) to register the first account (401) with the mapper system (1);
c. linking the first account (401) with the map (200) so that limitations (200) appearing in the map (200) are associated with the first account (401);
d. restricting the ability of the financial institution (400A) to transfer money (423) to the second account (402);

17. The method of claim 16, comprising the step of generating a unique identifier (151) and associating the unique identifier (151) with the first account (401).

18. The method of claim 16, comprising the steps of:
a. providing a consumer (500) with access to the map (200) associated with his or her (500) account (401); and
b. hosting an interface (450) through which the first user (500) can access a consumer registration module (452).

19. The method of claim 16, comprising steps of:
a. adding (8) a new limitation (210) to the associated map (200); and
b. modifying (8) an existing limitation (210) in the associated map (200).

20. The method of claim 16, wherein said limitation (210) is selected from the list consisting of:
a. a group (310) of goods (800) and a specified amount (421) of funds can be used to purchase (9) the goods (800);
b. a group (310) of services (800) and a specified amount (421) of funds can be used to purchase (9) the services (800);
c. a date and time (605) by which a specified amount (421) of funds is to be used to purchase (9) goods (800) from a particular group (310);
d. a date and time (605) by which a specified amount (421) of funds is to be used to purchase (9) services (800) from a particular group (310);
e. a locality (219LL) from which a particular type (310) of goods (800 is to be purchased (9);
f. a locality (219LL) from which a particular type (310) of services (800) is to be performed (9); and
g. a locality (219LL) of the first financial institution (400A) that is processing the transaction (9).

21. The method of claim 16, comprising the steps of:
a. using a territory module (219) containing a territory policy (219P) and a list of territories (219) to add limitations (218) to maps (200) according to the territory policy (219P) for the first financial institution (400A), wherein the limitations (218) are based on the financial institution's (400A) location (219LL) within a territory (219T).

22. The method of claim 16, comprising the steps of:
a. using a financial institution (400A) territory locator (219L) to determine and link a financial institution (400A) with a specific territory (219T);
b. using a territory applicator (219A) to apply a territory policy (219P) to a financial institution (400A); said policy (219P) including a map (200) and a limitation (218) associated with the territory (219T) of the financial institution (400A);
c. a transaction territory policy (219P) containing a map (200) having a limitation (218), wherein the limitation (218) applies to a location of an underlying transaction between the first user (500A) and a second user (500B), and not a location of the financial institution (400A);
d. said transaction territory policy (219P) containing a locked map (200) wherein neither the first user (500A) nor the financial institution (400A) can change any limitations (218) associated with the locked map (200).

23. The method of claim 16, comprising the step of using a transaction territory module (219M) to recognize (219L) a locality (219LL) of a financial transaction (9) and link that locality (219LL) to a specific territory (219T); said module (219M) containing instructions to cause the mapper server (100) to:
a. use a territory locator (219L) to determine the locality (219LL) of the financial transaction (9);
b. use a territory locator applicator (219A) to apply a transaction territory policy (219P) containing a locked map (200) wherein neither the user (500A) nor the financial institution (400A) can change any limitations (218) associated with the map (200).

24. The method of claim 16, comprising the step of using the mapper server (100) to:
a. determine the first user's (500) identity from his or her unique identifier (510);
b. access maps (200) within the map database (201) to determine if any limitations (210) should be associated with the first user's (500) account (401); and
c. determine whether the first user (500) has the access rights (430) to change (145) any of the limitations (210).

25. The method of claim 16, comprising the steps of:
a. receiving a unique identifier (510) from the first user (500A),
b. directing the query generator (140) to request a map (200) associated with the user (500A) by the unique identifier (510);
c. receiving an invoice (615) of goods or services (800) to be purchased (9) from the second user (500B);
d. determining, from limitations (210) stored in the map, whether the first user (500A) has authorization (141A) to pay for the goods and services (800) being offered by the second user (500B);
e. sending (615S) an instruction (141A) to the first financial institution (400A) to transfer funds from the first account (401) to the second account (402) if the processor (120) and logic (125) positively determine the first user (500A) has authorization (141A) to pay for the goods and services (800); and
f. sending (615S) an instruction (141A) to the first financial institution (400A) to deny transferring funds from the first account (401) to the second account (402) if the processor (120) and logic (125) positively determine the first user (500A) has not got authorization (141A) to pay for the goods and services (800).

26. The method of claim 16 comprising the steps of:
a. providing a product database (300) and populating the database with:
i. product and service identifier codes (303);
ii. groups (310) each containing at least one product or service code (303);
iii. each group (310) containing at least one subgroup (311), each subgroup containing further product or service codes (303);
b. providing an information database (301) and populating the information database (301) with:
i. an information set (301D) associated with a particular product or service (303); each information set (301D) containing:
1. a description of the product/service (307);
2. components or ingredients of the product/service;
3. supply chain information including: manufacturer of the component or ingredient, wholesaler of product or service (303), and retailer of product (303) or service (303);
4. expiration date of the product or service (303) if the product or service (303) has an expiration date;
5. instructions selected from the set consisting of: fitting instructions, use instructions, disposal instructions, and safety instructions;
6. manufacturing information; and
7. warranty information.

27. The method of claim 25, wherein mapper logic (125) is configured to cause the mapper server (100) to:
a. prevent the first user (500A) from modifying (8) limitations (210) in the map (200) associated with the first account (500A); and
b. allow the first user (500A) to add and apply (8) other limitations (210) to the map (200) which are more restrictive (435) with respect to existing limitations (210) in the map (200).

28. The method of claim 25, wherein mapper logic (125) is configured to cause the mapper server (100) to: collect information from the first institution (400A) and from the first (500A) and second (500B) users in order evaluate whether the first user (500A) has authorization (141A) to complete a transaction (9) between the first (500A) and second (500B) user; wherein the information is selected from the group consisting of date and time (605) of the transaction (9), location (219LL) of the transaction (9), and location (219LL) of the first financial institution (400A).
